(19) United States
(12) Patent Application Publication
(10) Pub. No.: US 2022/0076142 A1
(43) Pub. Date: Mar. 10, 2022

(54) SYSTEM AND METHOD FOR SELECTING UNLABLED DATA FOR BUILDING LEARNING MACHINES

(71) Applicant: DARWINAI CORPORATION, Waterloo (CA)

(72) Inventors: Andrew Hryniowski, Warterloo (CA); Mohammad Javad Shafiee, Kitchener (CA); Alexander Wong, Waterloo (CA)

(21) Appl. No.: 17/469,140

(22) Filed: Sep. 8, 2021

Related U.S. Application Data
(60) Provisional application No. 63/075,811, filed on Sep. 8, 2020.

(51) Int. Cl. G06N 5/02; G06F 16/28; G06F 16/901

(52) U.S. Cl. CPC G06N 5/022; G06F 16/9024; G06F 16/288

(57) ABSTRACT

Systems and methods for selecting unlabeled data for building and improving the performance of a learning machine are disclosed. In an aspect, such a system may include a reference learning machine, a set of labeled data, and a learning machine analyzer. The learning machine analyzer is configured to receive the reference learning machine and the set of labeled data as inputs and analyze the inner working of the reference learning machine to produce a selected set of unlabeled data. In an aspect, the learning machine analyzer identifies and measures a relation between different input data samples and finds all pairwise relations to construct a relational graph. In an aspect, the relational graph visualizes how much the different input data samples are like each other in higher dimensions inside the reference learning machine.

### CLAIM OF PRIORITY UNDER 35 U.S.C. § 120

The present Application for Patent claims priority to Provisional Application No. 63/075,811 entitled “SYSTEM AND METHOD FOR SELECTING UNLABELED DATA FOR BUILDING LEARNING MACHINES,” filed Sep. 8, 2020, and assigned to the assignee hereof and hereby expressly incorporated by reference herein.

### FIELD

The present disclosure relates generally to the field of machine learning, and more specifically, to systems and methods for selecting unlabeled data for building and improving the performance of learning machines.

### BACKGROUND

Identifying unlabeled data for building machine learning models and improving their modeling performance is a very challenging task. As machine learning models often require a significant amount of data to train, creating a large set of labeled data by having human experts manually annotate the whole set of unlabeled data is very time-consuming and error-prone and requires significant human effort to achieve; this process is associated with a significant cost as well. The current methods for building learning machines using unlabeled data, or small sets of labeled data are highly limited in their functionality and how to be used to improve the performance of different learning machines.

Furthermore, selecting the unlabeled data to use in building learning machines is significantly challenging, specifically when it does not provide a proper uncertainty in its decision-making.

Thus, needs exist for systems, devices, and methods for selecting unlabeled data for building and improving the performance of learning machines.

### SUMMARY

Provided herein are example embodiments of systems, devices, and methods for selecting unlabeled data for building and improving the performance of learning machines.

In an example embodiment, there is a system for selecting unlabeled data for building and improving the performance of a learning machine includes a reference learning machine, a set of labeled data, and a learning machine analyzer that receives the reference learning machine and the set of labeled data as inputs and analyzes the inner working of the reference learning machine to produce a selected set of unlabeled data.

In an example embodiment, there is a method for selecting unlabeled data for building and improving the performance of a learning machine, the method comprising receiving a reference learning machine, receiving a set of labeled data as input data samples, and analyzing an inner working of the reference learning machine to produce a selected set of unlabeled data.

In an example embodiment, there is a non-transitory computer-readable medium storing instructions executable by a processor. The instructions including instructions for receiving a reference learning machine, receiving a set of labeled data as input data samples, and analyzing an inner working of the reference learning machine to produce a selected set of unlabeled data.

This Summary is provided to introduce a selection of concepts in a simplified form that are further described below in the Detailed Description. This Summary is not intended to identify key features or essential features of the claimed subject matter, nor is the Summary intended to be used to limit the scope of the claimed subject matter. Moreover, it is noted that the invention is not limited to the specific embodiments described in the Detailed Description and/or other sections of this document. Such embodiments are presented herein for illustrative purposes only. Additional features and advantages of the invention will be set forth in the descriptions that follow, and in part will be apparent from the description, or may be learned by practice of the invention. The objectives and other advantages of the invention will be realized and attained by the structure particularly pointed out in the written description, claims and the appended drawings.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIG. 1 illustrates an exemplary system for evaluating and selecting unlabeled data to annotate and to build and improve the performance of learning machines, according to some embodiments of the present invention.

FIG. 2 illustrates another exemplary system for evaluating and selecting unlabeled data to annotate and to build and improve the performance of learning machines, according to some embodiments of the present invention.

FIG. 3 illustrates another exemplary system for evaluating and selecting unlabeled data to annotate and to build and improve the performance of learning machines, according to some embodiments of the present invention.

FIG. 4 illustrates an exemplary system to create a better speech recognizer system, according to some embodiments of the present invention.

FIG. 5 illustrates an exemplary system for evaluating and selecting unlabeled data to annotate and to build and improve the performance of learning machines without human annotation, according to some embodiments of the present invention.

FIG. 6 illustrates an exemplary overall platform for various embodiments and process steps, according to some embodiments of the present invention.

FIG. 7 is a flow diagram illustrating an example method in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The following disclosure describes various embodiments of the present invention and method of use in at least one of its preferred, best mode embodiment, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Generally, embodiments of the present disclosure include systems and methods for evaluating and selecting unlabeled data to annotate and to build and improve the performance of learning machines. In some embodiments, the system of the present disclosure may evaluate and select the best or substantially best unlabeled data. The system may include a reference learning machine, a set of labeled data, a big pool of unlabeled data, a learning machine analyzer and a data analyzer.

In some embodiments, various elements of the system of the present disclosure, e.g., the reference learning machine, the machine learning analyzer and the data analyzer may be embodied in hardware in the form of an integrated circuit chip, a digital signal processor chip, or on a computer. Learning machines and the analyzers may be also embodied in hardware in the form of an integrated circuit chip or on a computer. Elements of the system may also be implemented in software executable by a processor, in hardware or a combination thereof.

Generally, to train a reference learning machine L, a set of labeled training data D is required where the reference learning machine learns to produce appropriate values given the inputs in the training set D. The current approach to train a learning machine L is to provide the biggest possible set of training data D and use as many training samples as possible to produce a reference learning machine with the best possible performance. However, acquiring enough labeled training data is very time consuming, error prone and associated with a significant cost. As such, identifying the most important samples to improve the performance of the reference learning machine is highly desired.

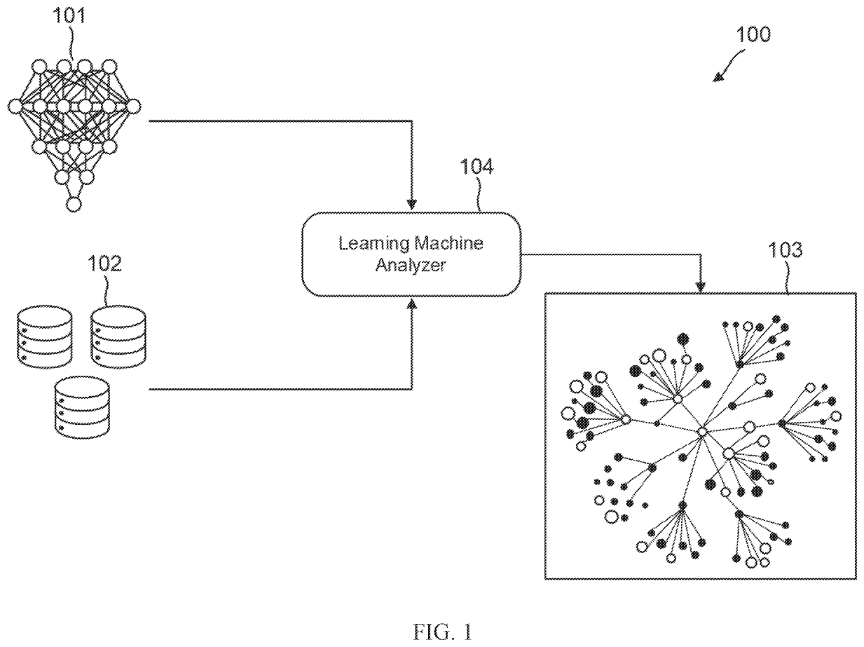

Referring to FIG. 1, an example of a system 100, according to some embodiments, is illustrated. In some embodiments, the system 100 may include a reference learning machine 101, labeled data 102, and a learning machine analyzer 104. The learning machine analyzer 104 may receive the reference learning machine 101 and the set of labeled data 102 as the inputs. Additionally, the learning machine analyzer 104 may analyze the inner working of the reference learning machine 101. The learning machine analyzer F(.) 104, may pass the labeled data 102 into the reference learning machine 101. Based on the different activations inside the reference learning machine, the learning machine analyzer 104 may construct a mapping graph which encodes how the reference learning machine interprets and sees the training data. In some embodiments, the learning machine analyzer 104 approximates how the reference learning machine 101 models each input data. To do this approximation, the learning machine analyzer 104 may identify and measure the relation between different input data samples and finds all pairwise relations to construct the relational graph 103.

In some embodiments, the constructed relational graph 103 may encode how different training samples are treated by the reference learning machine 101 in terms of their similarity (or dissimilarity). The constructed relational graph 103 may help one visualize how much the different samples are similar to each other (or dissimilar) in higher dimensions inside the reference learning machine and provide a better interpretation to visualize that. In some embodiments, the relational graph 103 may provide data on how much the different samples are similar or dissimilar to each other in higher dimensions inside the reference learning machine. The data of the relational graph 103 may be used by the system to make determinations on similarity or dissimilarity. The provided information by the constructed relational graph 103 may be used to understand the similarity (or dissimilarity) of training samples in the reference learning machine.

In some embodiments, the learning machine analyzer 104 may use the activation values extracted from one or more processing layers in the reference learning machine 101 to interpret how the reference learning machine maps the input data samples into the new space. The activation vector A_i extracted from the reference learning machine 101, may be processed and projected to a new vector V_i which may be designed to better highlight the similarity between samples. The vector V_i may have a much lower dimension compared to the vector A_i and as such may better encode the relation and similarity between the input samples. For example, the vector V_i may have a dimension that is one or more orders of magnitude lower compared to the vector A_i. Representing the samples in the lower dimension may better encode the relationship between samples and may show the similarity among them compared to a higher dimension.

In some embodiments, the vector V_i may be constructed by considering the label information available from the set of labeled sample data. The learning machine analyzer 104 uses the labeled data to calculate an optimal function to transfer the information from A_i to V_i where the similar samples from the same class label are positioned close to each other in the space associated to V_i and encodes them in the relational graph 103. The small set of labeled data may be used as a training set for the learning machine analyzer 104 to analyze and understand how the reference learning machine 101 is mapping data samples to discriminate and classify them.

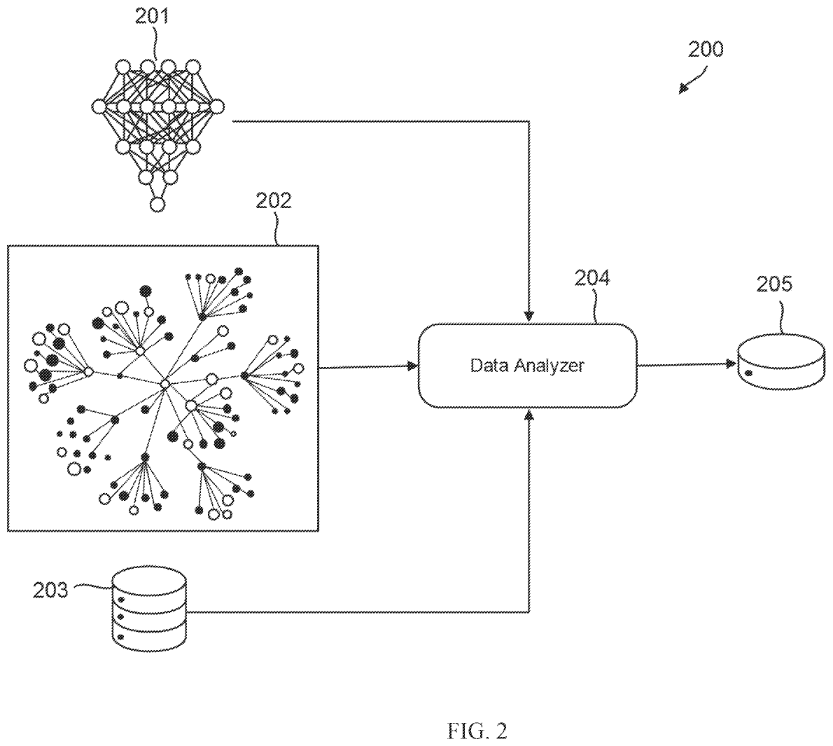

Referring to FIG. 2, in some embodiments, the data analyzer 204 may receive the reference learning machine 201, the output of the reference learning machine 201 and the pool of unlabeled data 203 as inputs and produce a subset of data samples 205. The subset of data samples 205 may be annotated and used for re-training the reference learning machine to improve the performance of the reference learning machine. The data analyzer 204 may measure the uncertainty of the reference learning machine 201 in classifying the unlabeled data 203 in the pool and calculate how much the reference learning machine is uncertain in classifying each sample. The importance of each unlabeled sample may be measured by the data analyzer 204 and all the unlabeled samples may be ranked on how much they can help the reference learning machine to improve its performance if they were added to the training data.

The similarity graph 202 constructed by the learning machine analyzer F(.) may be used by the data analyzer K(.), 204 to interpret the possible labels for the unlabeled data. Additionally, the similarity graph 202 constructed by the learning machine analyzer F(.) may be used by the data analyzer K(.), 204 to measure the uncertainty of the model for classifying the unlabeled input samples. The data analyzer 204 may find a proper position for an input sample to be added to the relational graph and based on that estimates how uncertain the reference learning machine is when classifies the unlabeled sample. The measure of how uncertain the reference learning machine is may be calculated for each unlabeled sample in the pool of data and then the measure of how uncertain the reference learning machine is for each unlabeled sample are ranked by the data analyzer 204 in a list.

In some embodiments, the data analyzer K(.) may identify a pre-defined portion of the unlabeled data in one pass, as the output (e.g., data samples 205), which may improve the performance of the reference learning machine 201 the most. The selected unlabeled data may be identified based on the selected unlabeled data's importance by the data analyzer 204 to be added to the training set.

In some embodiments, the data analyzing process, as performed by the data analyzer 204, may be done in one batch and the required subset of samples may be identified at once. In some embodiments, the required set of samples are identified gradually and outputted in the different subsequent steps. The number of samples in each step may be tuned based on the application.

### Selecting Unlabeled Data for Building an Image Classification Learning Machines—Example 1

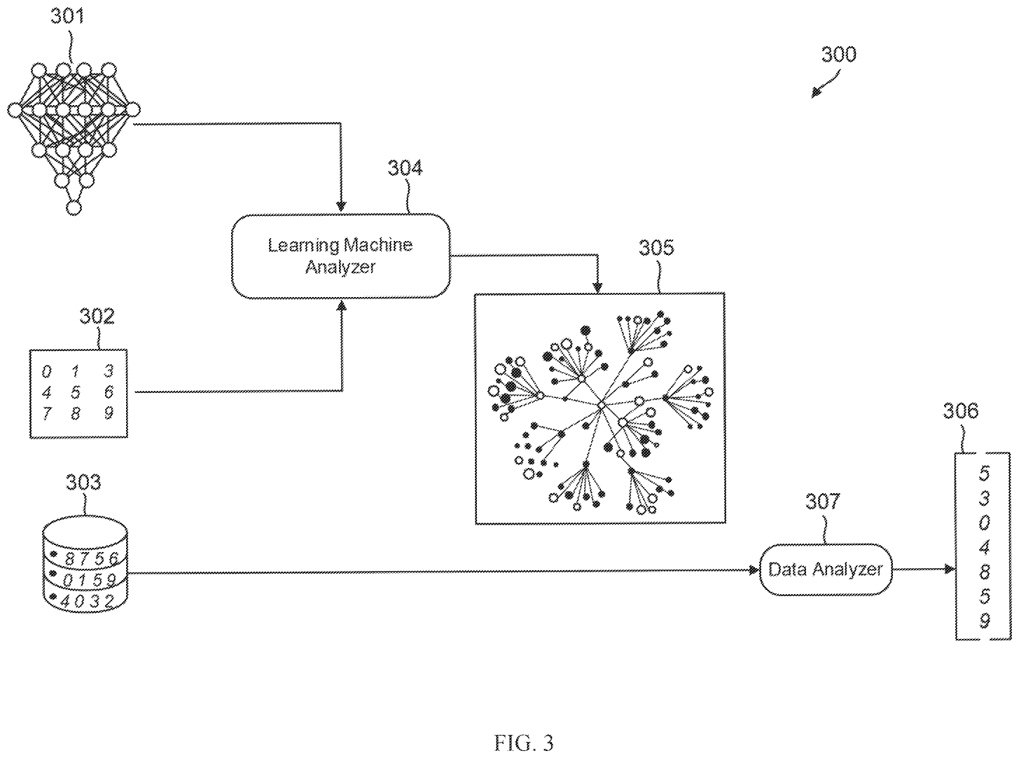

In some exemplary operations, the system of the present disclosure may be used to improve the performance of a reference learning machine for an image classification task. Referring to FIG. 3, a learning machine analyzer 304 may use a small set of labeled images 302 for different class labels in the image classification task, and a trained reference learning machine 301 to construct a relational graph 305 for the input images. A pool of unlabeled input images 303 may then be fed to the learning machine analyzer 304 to extract the vector V_i from the activation vector A_i for each sample separately. The extracted information by the learning machine analyzer 304 which is in a lower dimension compared to the activation vector is passed to a data analyzer 307 to measure how uncertain the reference learning machine 301 is in classifying the unlabeled input images 303 and rank them based on their uncertainties. A human user may be asked to annotate the selected portion of unlabeled images 306 and add them to the training set and create a larger labeled data to retrain the reference learning machine 301. The data analyzer 307 may use the relational graph 305 generated by learning machine analyzer 304 to understand how the reference learning machine 301 processes the data samples and what is the relationship among samples when they are fed to the reference learning machine 101. This process may help the data analyzer 307 to measure the uncertainty of the reference learning machine 301 and identify the most important unlabeled images to be annotated by the human user and be added to the training set.

### Selecting Unlabeled Data for Building a Speech Recognizer Learning Machines—Example 2

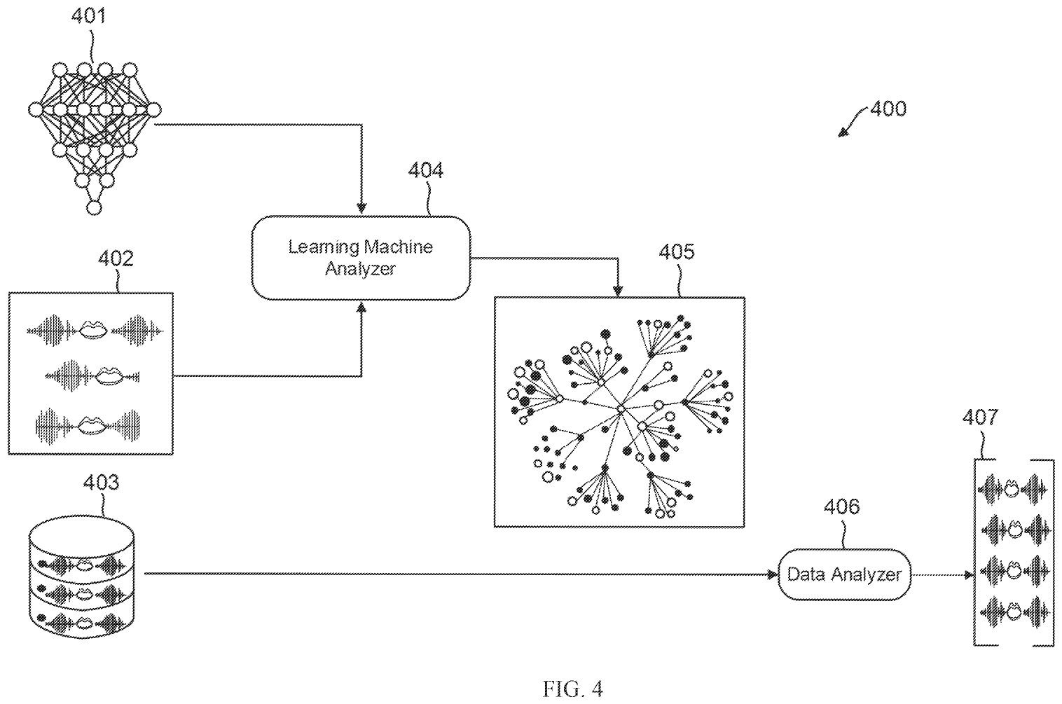

Referring to FIG. 4, in some exemplary operations, the system of the present disclosure may be used to create a better speech recognizer system. The small set of labeled speech 402 along with the reference learning machine 401 that may be used to recognize the small set of labeled speech 402 may be passed to the learning machine analyzer 404. The small set of labeled speech 402 along with the reference learning machine 401 may be used by the learning machine analyzer 404 to create the relational graph of speech of samples 405 and interpret the reference learning machine 401. In the next step, the pool of unlabeled speech samples 403 may be fed into the learning machine analyzer 404 to extract the pool of unlabeled speech samples' lower dimension representative vector V_i and interpret how the reference learning machine 401 processes the pool of unlabeled speech samples in the higher dimension of activation vector. The extracted information by the learning machine analyzer 404 may be used by the data analyzer 406 to measure how important each unlabeled speech sample is to improve the performance of speech recognizer. The data analyzer 406 may identify the most important unlabeled speech samples in the 407 set and may ask the user to annotate the most important unlabeled speech samples. The new labeled samples 407 may be added to the training set and the reference learning machine may be retrained based on the new labeled samples 407.

In some other exemplary operations, the system of the present disclosure may be used for other data types such as time-series and tabular data. The processes to identify the most important samples may be similar to other use cases provided in the previous examples.

### Selecting Unlabeled Data for Building Learning Machines without Annotation

In some embodiments, the system of the present disclosure may identify the important unlabeled data samples for the reference learning machine model. However, the identified samples may be used to re-train the reference learning machine without being annotated.

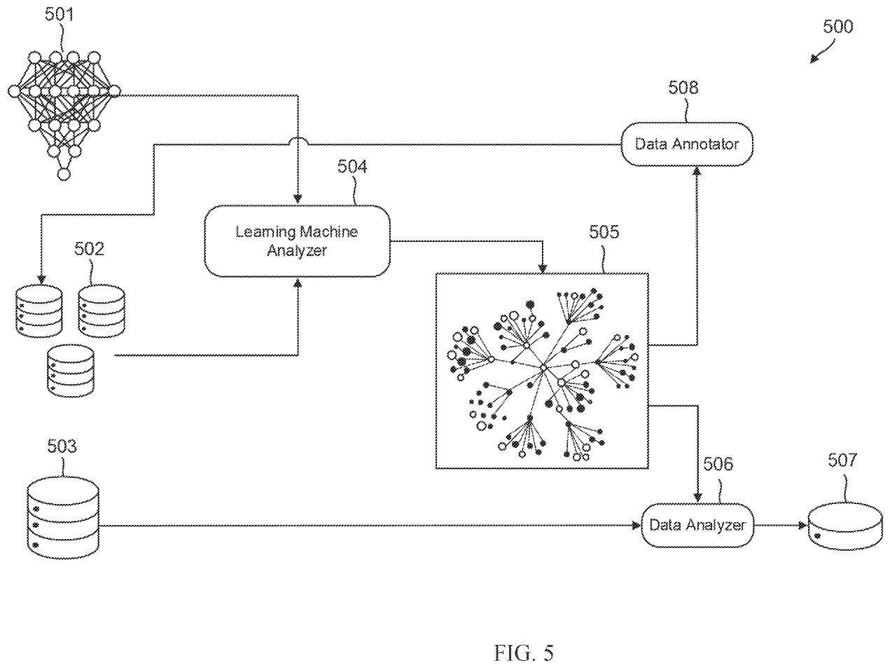

Referring to FIG. 5, the system may include a data analyzer 506 that processes unlabeled data samples from pool 503 given a similarity graph 505 created by a learning machine analyzer 504 and selects unlabeled samples 507. A data annotator 508 annotates the selected unlabeled samples 507 automatically without asking a human user to annotate the selected unlabeled samples 507, and then adds the annotated previously selected unlabeled samples to the set of available training data 502. The selected unlabeled samples may be annotated by the data annotator and may be added to the labeled set for improving the model's accuracy.

In some embodiments, the data annotator 508 estimates the possible correct labels for each unlabeled sample 507 in the set given the constructed similarity graph 505. The selected labels may be associated with a confidence value generated by the data annotator 508, and which may be used in re-training as a soft measure compared to the samples annotated by a human user. This process may help the model to improve the model's performance automatically and without the user's intervention and in an unsupervised process.

In some embodiments, the learning machine analyzer may identify the most important unlabeled sample in the pool 503 and automatically annotates the most important unlabeled sample in the pool 503 to be added to the training set. This process may be performed iteratively by adding one important sample every time. In some embodiments, the data analyzer may identify a batch of unlabeled samples to be used in the retraining of the reference learning machine. The data annotator 508 may annotate the batch of unlabeled samples with the labels and adds the batch of now labeled samples to the training set.

### System Architecture

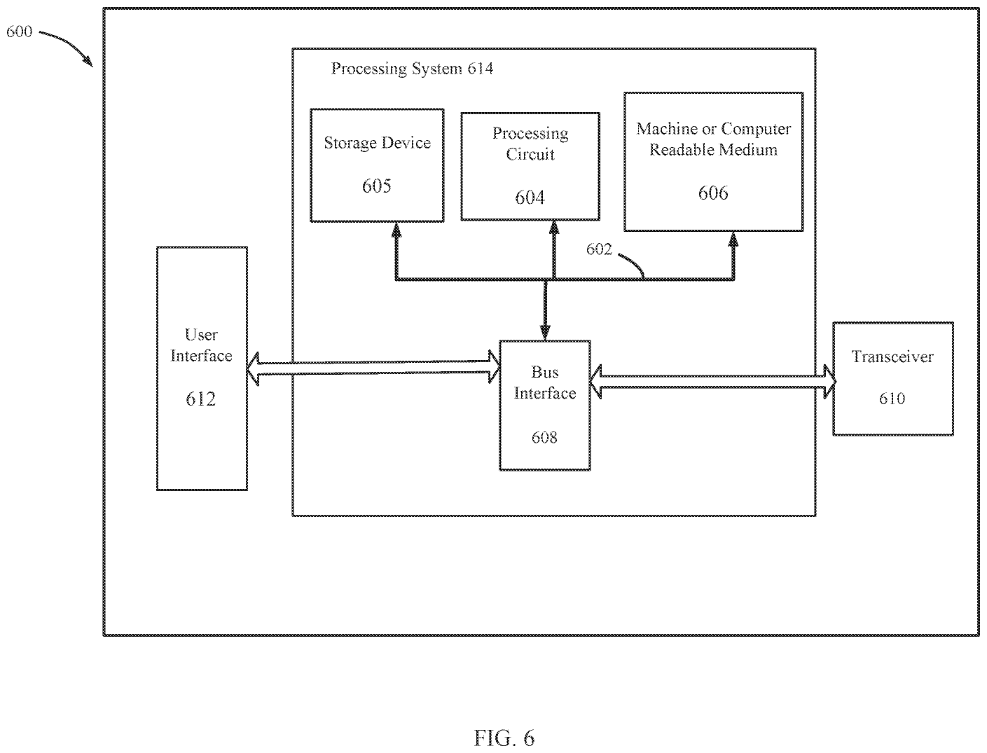

FIG. 6 illustrates an exemplary overall platform 600 in which various embodiments and process steps disclosed herein can be implemented. In accordance with various aspects of the disclosure, an element (for example, a host machine or a microgrid controller), or any portion of an element, or any combination of elements may be implemented with a processing system 614 that includes one or more processing circuits 604. Processing circuits 604 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 604 may be used to implement any one or more of the various embodiments, systems, algorithms, and processes described above. In some embodiments, the processing system 614 may be implemented in a server. The server may be local or remote, for example in a cloud architecture.

In the example of FIG. 6, the processing system 614 may be implemented with a bus architecture, represented generally by the bus 602. The bus 602 may include any number of interconnecting buses and bridges depending on the specific application of the processing system 614 and the overall design constraints. The bus 602 may link various circuits including one or more processing circuits (represented generally by the processing circuit 604), the storage device 605, and a machine-readable, processor-readable, processing circuit-readable or computer-readable media (represented generally by a non-transitory machine-readable medium 606). The bus 602 may also link various other circuits such as timing sources, peripherals, voltage regulators, and power management circuits, which are well known in the art, and therefore, will not be described any further. The bus interface 608 may provide an interface between bus 602 and a transceiver 610. The transceiver 610 may provide a means for communicating with various other apparatus over a transmission medium. Depending upon the nature of the apparatus, a user interface 612 (e.g., keypad, display, speaker, microphone, touchscreen, motion sensor) may also be provided.

The processing circuit 604 may be responsible for managing the bus 602 and for general processing, including the execution of software stored on the non-transitory machine-readable medium 606. The software, when executed by processing circuit 604, causes processing system 614 to perform the various functions described herein for any apparatus. Non-transitory machine-readable medium 606 may also be used for storing data that is manipulated by processing circuit 604 when executing software.

One or more processing circuits 604 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, or any other types of software, whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, or any other any suitable means.

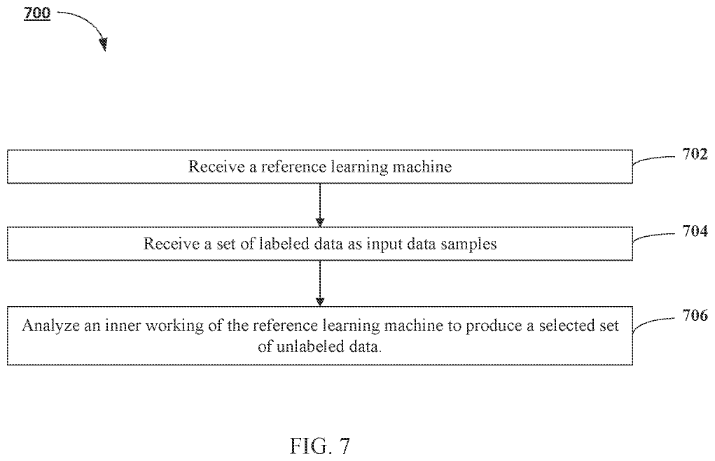

FIG. 7 is a flow diagram illustrating an example method 700 in accordance with the systems and methods described herein. The method 700 may be a method for selecting unlabeled data for building and improving performance of a learning machine. The method 700 may include receiving a reference learning machine (702), receiving a set of labeled data as input data samples (704), and analyzing an inner working of the reference learning machine to produce a selected set of unlabeled data (706).

Receiving a reference learning machine (702) may include receiving information on the reference learning machine over-the-air, from a storage, or from some other data source such as a data input. Receiving the reference learning machine (702) may include requesting the reference learning machine, getting data related to the reference learning machine, e.g., a design, and processing that data.

Receiving a set of labeled data as input data samples (704) may include receiving information on the reference learning machine over-the-air, from a storage, or from some other data source such as a data input. Receiving the set of labeled data as input data samples (704) may include requesting the set of labeled data, getting the data, and processing the data.

Analyzing an inner working of the reference learning machine to produce a selected set of unlabeled data (706) may include identifying a relation between different input data samples of the set of labeled data. Additionally, analyzing an inner working of the reference learning machine to produce a selected set of unlabeled data (706) may include measuring a relation between different input data samples of the set of labeled data. Analyzing an inner working of the reference learning machine to produce a selected set of unlabeled data (706) may also include finding all pairwise relations to construct a relational graph.

Analyzing an inner working of the reference learning machine to produce a selected set of unlabeled data (706) may include providing a visualization of how much the different input data samples are similar to each other in higher dimensions inside the reference learning machine. Additionally, one or more first activation vectors extracted from the reference learning machine are processed and projected to a second vector which is designed to highlight similarities between the input data samples. The second vector may have a much lower dimension compared to the one or more first activation vectors. Analyzing an inner working of the reference learning machine to produce a selected set of unlabeled data (706) may include automatically annotate the selected set of unlabeled data.

In some embodiments, a system of the present disclosure may generally include a reference learning machine, initial set of labeled data, the pool of unlabeled data, a machine learning analyzer, and a data analyzer.

In some embodiments, the machine learning analyzer may evaluate the reference learning machine which was trained on an initial set of data and may understand how the reference learning machine represents the input data in a higher dimensional space inside the reference learning machine to distinguish between different samples in the input data.

In some embodiments, the data analyzer may evaluate a pool of unlabeled data and measure the uncertainty of the reference learning machine by using I) the unlabeled data and II) the extracted knowledge by the machine learning analyzer. The data analyzer may select a subset of data from the pool of unlabeled data which improves the performance of the reference learning machine.

In some embodiments, the data analyzer may identify a subset of unlabeled data iteratively to be annotated and pass the subset of unlabeled data to the machine learning analyzer to update the reference learning machine and improve the performance of the reference learning machine.

In some embodiments, the data analyzer may identify only a single unlabeled data at each iteration of the above process. The samples are annotated iteratively and one by one to be added to the training set and passed to the machine analyzer to update the reference learning machine by the new and larger training set.

In some embodiments, the data analyzer may identify a subset of unlabeled data to be added to the initial pool of labeled data without any annotation which may improve the reference learning machine accuracy when the subset of unlabeled data is used by the learning machine analyzer in training the learning machine again.

In some embodiments, the data analyzer may identify a single unlabeled data to be added to the initial set of labeled data and without annotation requirement to build and improve the reference learning machine.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for selecting unlabeled data for building and improving the performance of a learning machine. The system also includes a reference learning machine; a set of labeled data, and a learning machine analyzer configured to receive the reference learning machine and the set of labeled data as input data samples and analyze an inner working of the reference learning machine to produce a selected set of unlabeled data. Other embodiments of this aspect include corresponding computer systems, apparatus, and computer programs recorded on one or more computer storage devices, each configured to perform the actions of the methods.

Implementations may include one or more of the following features. The system where the learning machine analyzer identifies and measures a relation between different input data samples of the set of labeled data and finds all pairwise relations to construct a relational graph. The relational graph provides a visualization of how much the different input data samples are similar to each other in higher dimensions inside the reference learning machine. One or more first activation vectors extracted from the reference learning machine are processed and projected to a second vector which is designed to highlight similarities between the input data samples. The second vector has a much lower dimension compared to the one or more first activation vectors. The system further may include a data annotator to automatically annotate the selected set of unlabeled data. Implementations of the described techniques may include hardware, a method or process, or computer software on a computer-accessible medium.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step may be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein may be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media may include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

What is claimed is:

1. A system for selecting unlabeled data for building and improving performance of a learning machine, comprising:
a reference learning machine;
a set of labeled data; and
a learning machine analyzer that:
receives the reference learning machine and the set of labeled data as input data samples, and
analyzes an inner working of the reference learning machine to produce a selected set of unlabeled data.

2. The system of claim 1, wherein the learning machine analyzer identifies and measures a relation between different input data samples of the set of labeled data and finds pairwise relations to construct a relational graph.

3. The system of claim 2, wherein the relational graph provides a visualization of how much the different input data samples are similar to each other in higher dimensions inside the reference learning machine.

4. The system of claim 1, wherein one or more first activation vectors extracted from the reference learning machine are processed and projected to a second vector which is designed to highlight similarities between the input data samples.

5. The system of claim 4, wherein the second vector has a much lower dimension compared to the one or more first activation vectors.

6. The system of claim 1, further comprises a data annotator to automatically annotate the selected set of unlabeled data.

7. A method for selecting unlabeled data for building and improving performance of a learning machine, the method comprising:
receiving a reference learning machine;
receiving a set of labeled data as input data samples; and
analyzing an inner working of the reference learning machine to produce a selected set of unlabeled data.

8. The method of claim 7, further comprising identifying and measuring a relation between different input data samples of the set of labeled data and finding pairwise relations to construct a relational graph.

9. The method of claim 8, further comprising providing a visualization of how much the different input data samples are similar to each other in higher dimensions inside the reference learning machine.

10. The method of claim 7, wherein one or more first activation vectors extracted from the reference learning machine are processed and projected to a second vector which is designed to highlight similarities between the input data samples.

11. The method of claim 10, wherein the second vector has a much lower dimension compared to the one or more first activation vectors.

12. The method of claim 7, further comprising automatically annotate the selected set of unlabeled data.

13. A non-transitory computer-readable medium storing instructions, executable by a processor, the instructions comprising instructions for:
receiving a reference learning machine;
receiving a set of labeled data as input data samples; and
analyzing an inner working of the reference learning machine to produce a selected set of unlabeled data.

14. The non-transitory computer-readable medium of claim 13, further including instructions for identifying and measuring a relation between different input data samples of the set of labeled data and finding pairwise relations to construct a relational graph.

15. The non-transitory computer-readable medium of claim 14, wherein the relational graph provides a visualization of how much the different input data samples are similar to each other in higher dimensions inside the reference learning machine.

16. The non-transitory computer-readable medium of claim 13, wherein one or more first activation vectors extracted from the reference learning machine are processed and projected to a second vector which is designed to highlight similarities between the input data samples.

17. The non-transitory computer-readable medium of claim 16, wherein the second vector has a much lower dimension compared to the one or more first activation vectors.

18. The non-transitory computer-readable medium of claim 13, further comprising automatically annotate the selected set of unlabeled data.
